(19) United States
(12) Patent Application Publication
(10) Pub. No.: US 2009/0300568 A1
(43) Pub. Date: Dec. 3, 2009

(54) Bus interface design apparatus and bus interface design method

(75) Inventor: Yasuaki Kuroda, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/453,236

(22) Filed: May 4, 2009

(30) Foreign Application Priority Data
Jun. 3, 2008 (JP) 2008-145476

(51) Int. Cl. G06F 17/50

(52) U.S. Cl. 716/10

(57) ABSTRACT

A design method of a bus interface that includes an I/F interposed between chips, includes determining a bus width of the bus interface between chips and a type of the bus interface, based on a physical constraint condition between the chips, and automatically generating a bus IP core that comprises a circuit configured in accordance with the determined bus width and the bus interface.

### BACKGROUND

1. Field of the Invention

The present invention relates to a bus interface design apparatus, and a bus interface design method.

2. Description of Related Art

In recent years, along with the advance in technology of a system LSIs (large scale integration), it has been widely practiced to mount high speed bus interfaces. At the same time, PCBs (print circuit board) have also been advanced to be operable at high speed and to be highly integrated. In accordance with this trend, it has been getting more important to design with a consideration for cooperating both system LSIs and PCBs. Currently, packages and bus interfaces are designed manually by system LSI designers on the basis of physical constraint conditions of PCB, such as the component layout, the number of circuit board layers, and the circuit board material. An environment has been sought in which such design can be carried out more effectively.

Japanese Unexamined Patent Application Publication No. 2006-119951 (hereinafter referred to as Patent Document 1) discloses a system for designing an internal bus interface of a system LSI. Japanese Unexamined Patent Application Publication No. 2006-107309 (hereinafter referred to as Patent Document 2) discloses a bus interface design support apparatus. This bus interface design support apparatus automatically generates a bus interface by selecting an appropriate bus protocol for achieving an appropriate data transfer between modules.

FIG. 8 shows a functional block diagram of a bus interface design support apparatus disclosed in Patent Document 1. As shown in FIG. 8, a conventional bus interface design support apparatus 200 has an input unit 211, a control unit 212, a storage unit 213, a RAM (Random Access Memory) 214, a VRAM (Video Random Access Memory) 215, and a display unit 216. The storage unit 213 has a bus protocol library 213a and a bus bridge library 213b.

Interface information of modules is input by the input unit 211. It should be noted that the interface information of modules includes information, such as definition of signals (clock signal, select signal, read and write direction signal, read or write enable signal), timings of inputting and outputting each signal, a bus width (address and data), a transfer speed index (indicator (indicative value) of transfer speed), a circuit scale of the interface (indicator (indicative value) of a circuit scale), and a transaction ID (identification information upon a split transaction). The control unit 212 selects a bus bridge circuit that matches the interface information while accessing to the interface information, the bus protocol library 213a, and the bus library 213b. Note that the bus protocol library 213a and the bus bridge library 213b are stored in the storage unit 213 in advance. The control unit 212 outputs the result to the display unit 216, and then outputs the generated bus.

With reference to FIG. 9, a scheme of selecting an appropriate bus bridge is described hereinafter. As shown in FIG. 9, a source file is read (step SP101) to calculate the bus transfer bandwidth, and transfer speed analysis is carried out (step SP102). In the bus transfer speed analysis process, the read source file is analyzed, and then it is performed to count accesses to an address in a specific memory region of a memory device connected to the bus. In the bus transfer speed analysis process, it is achieved to select a bus protocol more properly by calculating the transfer speed with adding a response time that corresponds to the type of memory (whether it is an SRAM or a DRAM, for example) to be accessed and the type of bus protocol.

In the bus transfer speed analysis process, it is performed to receive an input of external information that is determined to be added by the designer of the bus interface. It should be noted that the external information is a design condition, and for example, information and conditions both used for calculating the required data transfer speed (hereinbelow, referred to as “external information A”) and conditions on selecting a bus protocol (hereinbelow, referred to as “external information B”) can be named.

Specifically, the external information A is information related to data traffic, such as a number of connected modules including master modules and slave modules, a bus width, operation clock speed, latency, and bus occupancy time and occupancy ratio.

The external information B is information related to determination on whether the speed is given priority (whether to give priority to conditions, such as selecting a larger bus width, selecting higher operation clock speed, and separating an address bus and a data bus), or whether the circuit scale is given priority (whether to give priority to a bus protocol that is more simple and makes an interface circuit smaller in scale).

After the step SP102, the control unit 212 accesses to the bus protocol library 213a stored in the storage unit 213, and selects a bus protocol that satisfies the data transfer speed calculated in the bus transfer speed analysis process (step SP103). At this time, it is performed to select the bus protocol after reflecting the conditions given by the external information as well, if the external information is input. Subsequently, the control unit 212 controls the display unit 216 to display the bus protocol selected in the step SP103 (step SP104), and determines whether or not the number of the selected bus protocol is plural (step SP105).

In the step SP105, if a plurality of bus protocols are selected, the control unit 212 asks the designer (user) to select any one of the displayed plurality of bus protocols via the input unit 211 (step SP106).

Subsequently, the control unit 212 generates design data of a bus interface that matches with the selected bus protocol (step SP107). At this time, if the bus interface has been selected with the inclusion of different types of bus protocols, the control unit 212 accesses to the bus bridge library, selects an appropriate bus bridge to connect these buses, and generates the design data of the bus interface. It should be noted that, in the step SP105, if one bus protocol is selected, the control unit 212 proceeds with the process of step SP107. After the step SP107, the control unit 212 terminates the bus interface design support process.

In these days, it has been getting popular to connect a plurality of system LSIs through a high speed bus interface in the technical field of large scale systems. However, the method according to Patent Document 1 is not capable of designing while considering the physical constraint conditions (such as a material of print circuit boards and a distance between the system LSIs) of the system LSIs. If a bus interface of a system LSI is generated in conformity only with logical constraint conditions (such as the protocol and the bus width) upon bus generation, problems arise such that the interface between the system LSIs does not stably operate, a target transfer bandwidth cannot be achieved, and the like because of the changes in electrical properties due to physical factors. Efficiency of the entire system design would be prevented by solving the above-explained problems by redesigning the parts other than the chips (such as a package substrate, a print circuit board, and cables).

### SUMMARY

The present inventors have found a problem that it has not been achieved to design with a consideration of physical constraint conditions between system LSIs (such as a material of print circuit boards, and a distance between the system LSIs for example).

A first exemplary aspect of an embodiment of the present invention is a design method of a bus interface that includes an I/F interposed between chips, including: determining a bus width of the bus interface between chips and a type of the bus interface, based on a physical constraint condition between the chips; and automatically generating a bus IP core that includes a circuit configured in accordance with the determined bus width and the bus interface.

A second exemplary aspect of an embodiment of the present invention is a bus interface design method including: reading a logical constraint condition between chips and the physical constraint condition between the chips; calculating a parameter required for a configuration of the bus interface; and automatically generating the bus interface by performing the configuration of the bus interface.

A third exemplary aspect of an embodiment of the present invention is a bus interface design apparatus including: a data readout unit that read out a bus interface design library and a physical constraint condition of chips, the bus interface design library being configured by registering a plurality of design purpose bus interfaces, each of the plurality of design purpose bus interfaces being for a bus that connects chips; a determinator that determines a bus width and the design purpose bus interface based on the physical constraint condition; and an executor that automatically generates a bus IP core that comprises a circuit configured in accordance with the determined bus width and the design purpose bus interface.

In the present invention, upon configuring a bus interface, physical constraint conditions (for example, a material of a print circuit board, distance information between LSIs, and the like) are also taken into account, in addition to normally used logical constraint conditions. In this way, it becomes possible to generate a bus interface that can be driven stably.

In accordance with the present invention, it is achieved to provide a bus interface design apparatus, and a bus interface design method for generating a bus interface which can be driven stably and satisfies physical constraint conditions upon designing the bus interface.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a diagram that shows a bus interface design system according to an exemplary embodiment of the present invention.

FIG. 2 is a block diagram that shows a bus interface design apparatus according to an exemplary embodiment of the present invention.

FIG. 3 is a diagram that shows an LSI including buses designed by the bus interface design apparatus according to an exemplary embodiment of the present invention.

FIG. 4 is a flow chart that shows a design method performed by a bus interface design apparatus according to an exemplary embodiment of the present invention.

FIG. 5 is a diagram that shows one example of a logical constraint file that is used or accessed by a bus interface design apparatus according to an exemplary embodiment of the present invention.

FIG. 6 is a diagram that shows one example of a physical constraint file that is used or accessed by a bus interface design apparatus according to an exemplary embodiment of the present invention.

FIG. 7 is a flow chart that shows a calculation method of a configuration parameter for a bus IP performed by a bus interface design apparatus according to an exemplary embodiment of the present invention.

FIG. 8 is a functional block diagram that shows a bus interface design support apparatus disclosed in Patent Document 1.

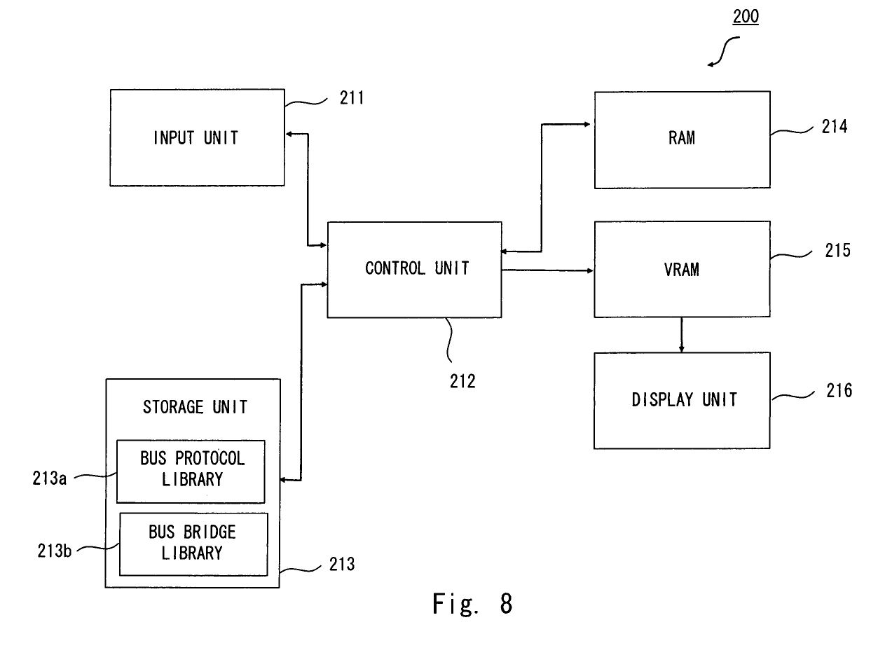

FIG. 9 is a flow chart that shows an operation of the bus interface design support apparatus disclosed in Patent Document 1.

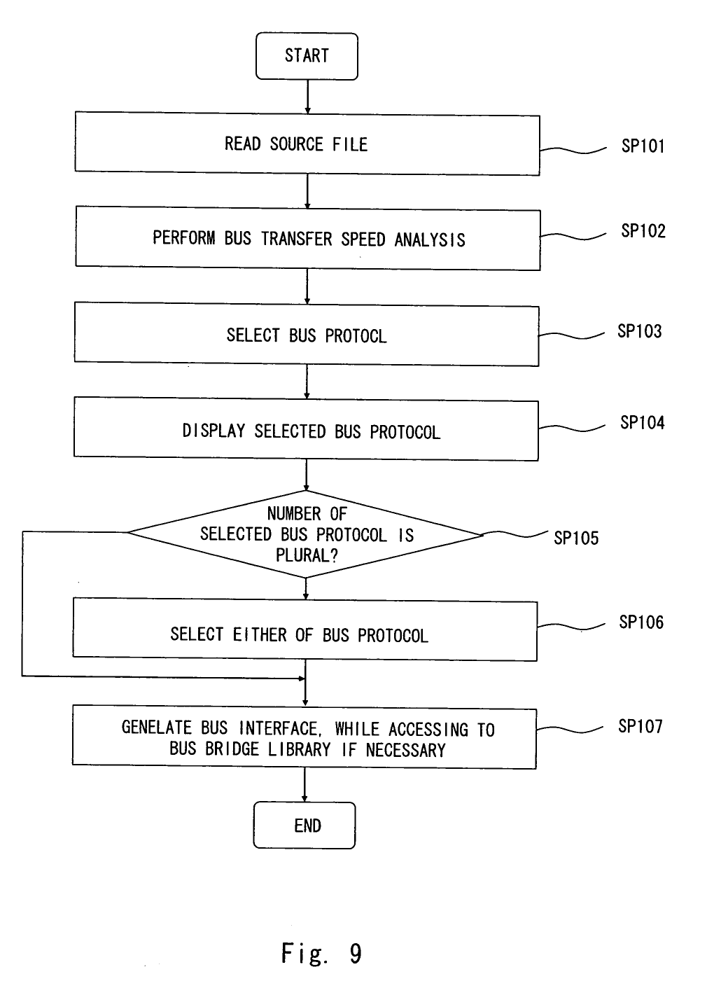

### DETAILED DESCRIPTION OF THE EXEMPLARY EMBODIMENTS

Hereinbelow, specific exemplary embodiments to which the present invention is applied are described in detail with reference to the drawings. These exemplary embodiments are given by applying the present invention to a bus interface design apparatus that is related to design of system LSIs and includes a bus interface interposed between a plurality of chips. The bus interface design apparatuses according to the exemplary embodiments herein are for designing a bus interface including an I/F interposed between a plurality of chips, and they determine the bus width of the bus interface between chips and the type of bus interface based on physical constraint conditions of the chips and automatically generate a bus IP core equipped with a circuit corresponding to the determined bus width and bus interface.

To realize this, as constraint information for generating a bus interface (hereinbelow, may also be referred to as a bus IP), it is configured to be capable of inputting logical constraint conditions, such as the protocol and the bus width, and physical constraint conditions, such as the material of print circuit board and information of distance between the LSIs. Subsequently, it is configured to be capable of handling a plurality of system LSIs as the logical and physical constraint conditions for generating a bus interface.

In addition, a configurable bus IP (Intellectual Property) core corresponding to the physical and logical constraint conditions is included in a bus interface design library that is to be accessed upon generation of a bus interface. Further, it is configured to calculate a configuration parameter to be allocated to the bus IP core from the logical and physical constraint conditions, and to provide a high speed interface (link) between the LSIs on the bus IP core for realizing a configuration capable of connecting the plurality of system LSIs with a high speed interface. The number of such high speed interfaces (links) is determined by considering the physical constraint conditions and a logical bandwidth calculated from the logical constraint conditions.

### First Exemplary Embodiment

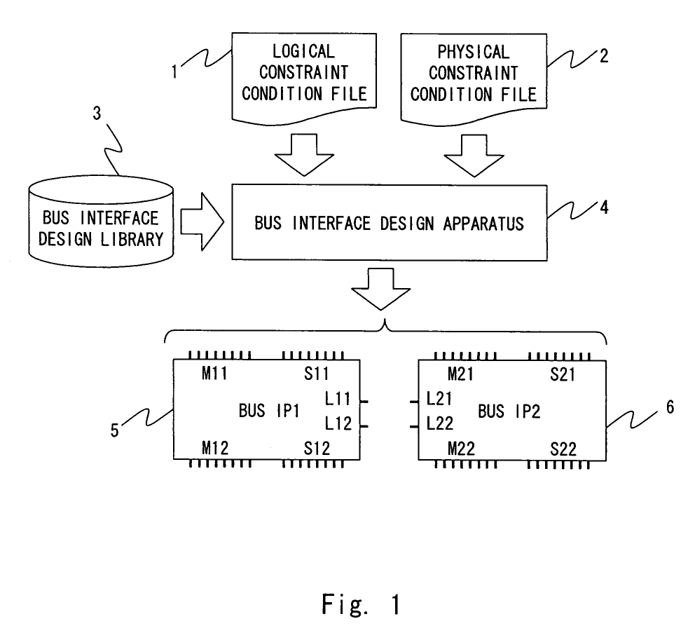

FIG. 1 is a diagram that shows a bus interface design system according to an exemplary embodiment of the present invention. The bus interface design system according to the present exemplary embodiment has a logical constraint condition file 1, a physical constraint condition file 2, a bus interface design library 3, and a bus interface design apparatus 4, and the bus interface design system designs bus interfaces 5 and 6.

The bus interface design system inputs logical and physical constraint conditions from the logical constraint condition file 1 and the physical constraint condition file 2, and generates the buses by performing a configuration of a configurable bus IP included in the bus interface design library 3, which is prepared in advance, on the basis of the inputted constraint conditions.

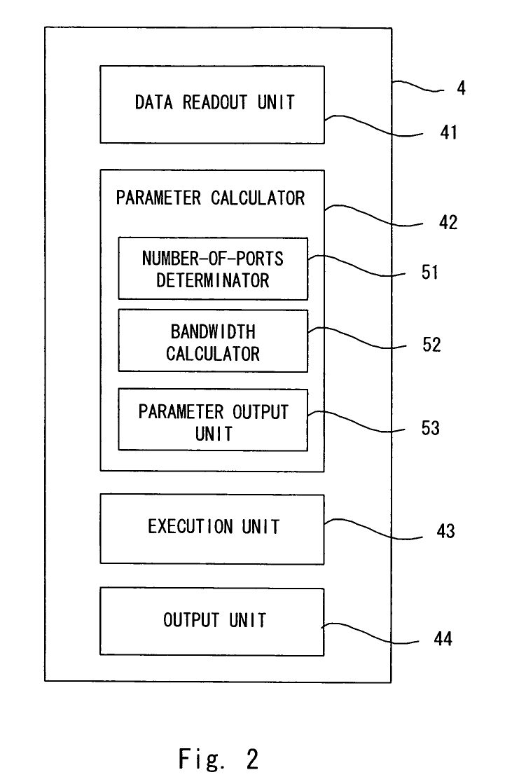

FIG. 2 is a block diagram that shows a bus interface design apparatus according to the present exemplary embodiment. As shown in FIG. 2, the bus interface design apparatus has a bus interface design library (not shown in FIG. 2), a data readout unit 41, a parameter calculator 42, an execution unit (configuration execution unit) 43, and an output unit (RTL output unit) 44.

The data readout unit 41 reads the logical and physical constraint conditions upon designing the bus interfaces. The parameter calculator 42 calculates a parameter required for configuration of the bus interfaces. The execution unit 43 executes a configuration of the bus interfaces. The output unit 44 outputs an RTL (Register Transfer Level), as a result of executing the configuration. The RTL represents the bus interface circuits with flipflop and combinational logical circuits.

The bus interfaces are interfaces for the buses that connect a plurality of system LSIs. The bus interfaces have a transmitting and receiving circuit that drives transmission lines (buses) connecting the system LSIs. Further, the bus interfaces have bus matrix units to arbitrarily connect one or more bus master modules, one or more bus slave modules, one or more bus master modules, and one or more bus slave modules.

The parameter calculator 42 calculates a property parameter (property adjusting parameter) of the transmitting and receiving circuit included in the bus interfaces. It should be noted that the bus interfaces have a high speed serial interface and/or a high speed parallel interface that drives a transmission line connecting the system LSIs, as described later. The property parameter(s) of the high speed serial interface and/or the high speed parallel interface may also be calculated by the parameter calculator 42.

The parameter calculator 42 may also output, instead of or together with the property parameter, other parameters (such as the clock frequency of the bus interfaces, the number of master ports, the number of slave ports, the data bus width of each port, the start addresses and the end addresses of the address regions (for the case of slaves), and the number of external high speed interfaces (number of links)). The bus interface design apparatus generates the bus interfaces by specifying these parameters as described later.

The parameter calculator 42 searches a database, which is configured to output the property parameter, with use of the physical constraint conditions as a search key in a look-up table manner. Specifically, the parameter calculator 42 has a number-of-port determinator 51, a bandwidth calculator 52, and a parameter output unit 53. The number-of-port determinator 51 determines the number of master ports and the number of slave ports both required to generate the bus matrix units. The bandwidth calculator 52 calculates a logical bandwidth (logical bandwidth value) required for a high speed interface connecting the system LSIs from the logical constraint conditions. The parameter output unit 53 calculates a number of interfaces capable of realizing the above logical bandwidth and a property parameter of the transmitting and receiving circuit that drives each interface, from the physical constraint conditions.

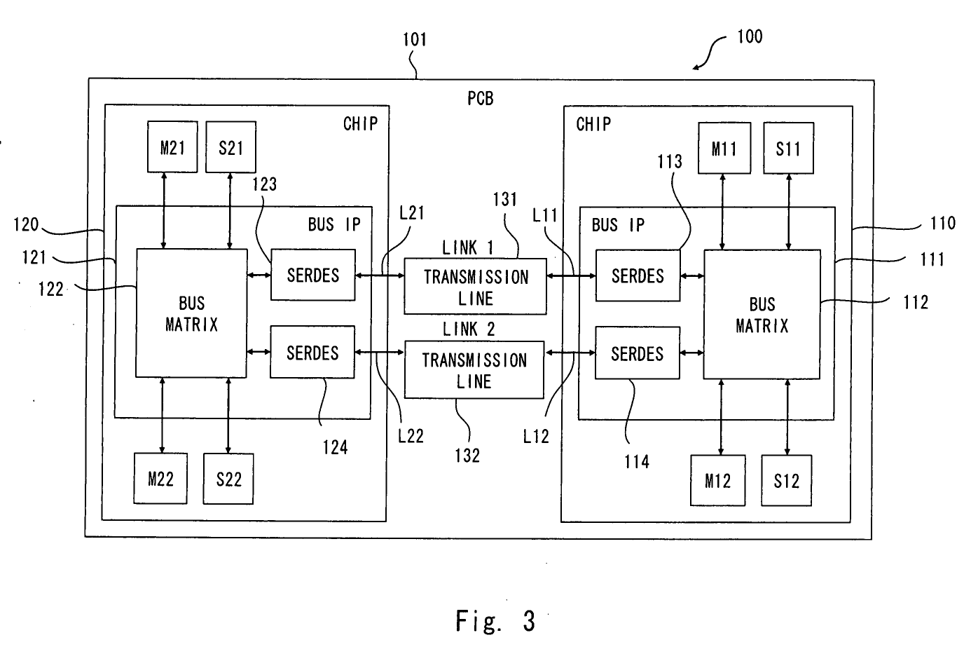

Next, the operation of the bus interface design apparatus according to the present exemplary embodiment is described. FIG. 3 is a diagram that shows an LSI including buses designed by the bus interface design apparatus according to the present exemplary embodiment.

First, the configuration of an LSI 100 shown in FIG. 3 is described. As shown in FIG. 3, the LSI 100 has system LSIs (CHIPs) 110 and 120 on a print circuit board (PCB) 101. The CHIPs 110 and 120 are connected by transmission lines 131 and 132.

Bus master modules M11, M12 and bus slave modules S11, S12 are embedded in the CHIP 110. These modules are connected with a bus IP (Intellectual Property) 111. A bus matrix 112 and SERDESes (SERializer/DESerializer) 113 and 114 are embedded in the bus IP 111. The bus matrix 112 functions as a cross bar switch. The SERDESes (SERializer/DESerializer) 113 and 114 function as high speed interfaces to communicate with the outside of the LSI 100. The SERDESes are circuits to convert serial and parallel with each other. The system interface of the SERDES 113 is connected to the bus matrix 112. The high speed serial interface of the SERDES 113 is connected to an external terminal L11 of the CHIP 110. Likewise, the system interface of the SERDES 114 is connected to the bus matrix 112. The high speed serial interface of the SERDES 114 is connected to an external terminal L12 of the CHIP 110. The external terminal L11 of the CHIP 110 is connected to the transmission line 131 that is wired on the PCB 101, and likewise, the external terminal L12 of the CHIP 110 is connected to the transmission line 132 that is wired on the PCB 101.

The CHIP 120 of the LSI 100 is also configured in the same manner as the CHIP 110. In other words, bus master modules M21, M22 and bus slave modules S21, S22 are embedded in the CHIP 120. These modules are connected by a bus IP 121. A bus matrix 122 and SERDESes 123 and 124 are embedded in the bus IP 121. The bus matrix 122 functions as a cross bar switch. The SERDESes functions as high speed interfaces to communicate with the outside of the LSI.

The system interface of the SERDES 123 is connected to the bus matrix 122. The high speed serial interface of the SERDES 123 is connected to an external terminal L21 of the CHIP 120. Likewise, the system interface of the SERDES 124 is connected to the bus matrix 122. The high speed serial interface of the SERDES 124 is connected to an external terminal L22 of the CHIP 120. The external terminal L21 of the CHIP 120 is connected to the transmission line 131 that is wired on the PCB 101. Likewise, the external terminal L22 of the CHIP 120 is connected to the transmission line 132 that is wired on the PCB 101.

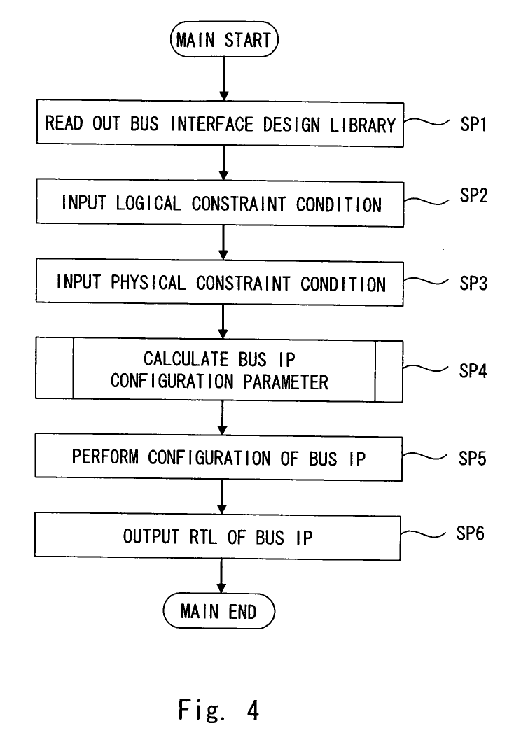

The bus interface design apparatus 4 has an object of automatically generating the bus IPs 111, 121 shown in FIG. 3. In the following description, detail descriptions of the operation of the bus interface design apparatus 4 are described. FIG. 4 is a flow chart that shows a processing method carried out by the bus interface design apparatus according to the present exemplary embodiment.

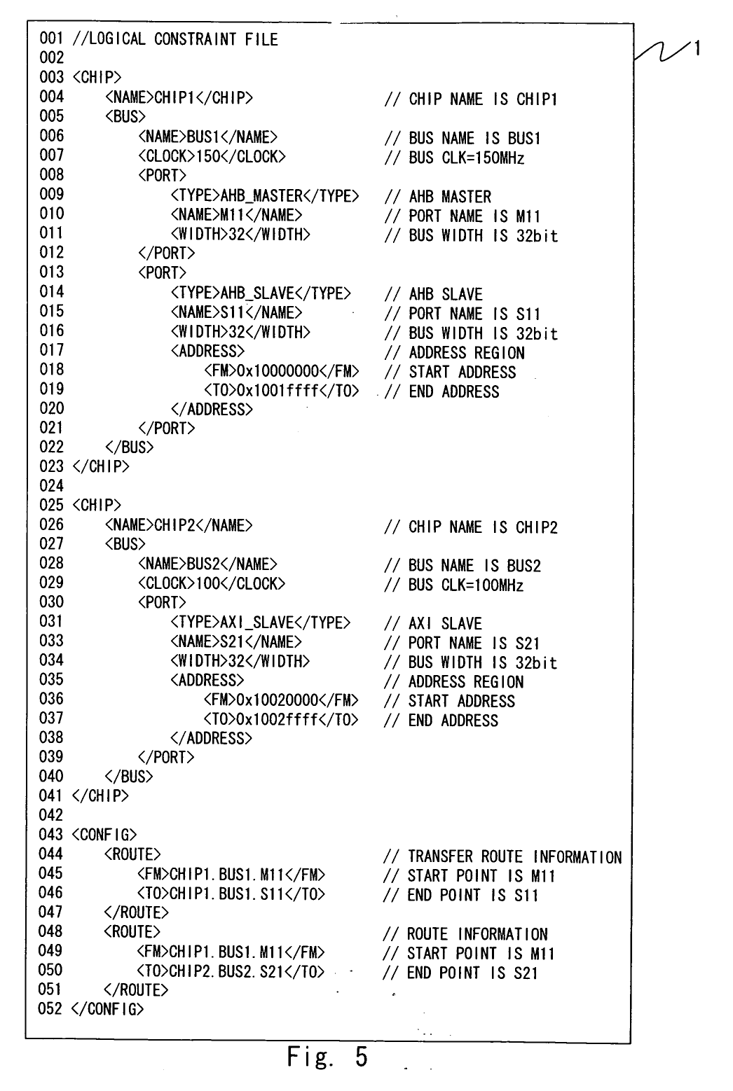

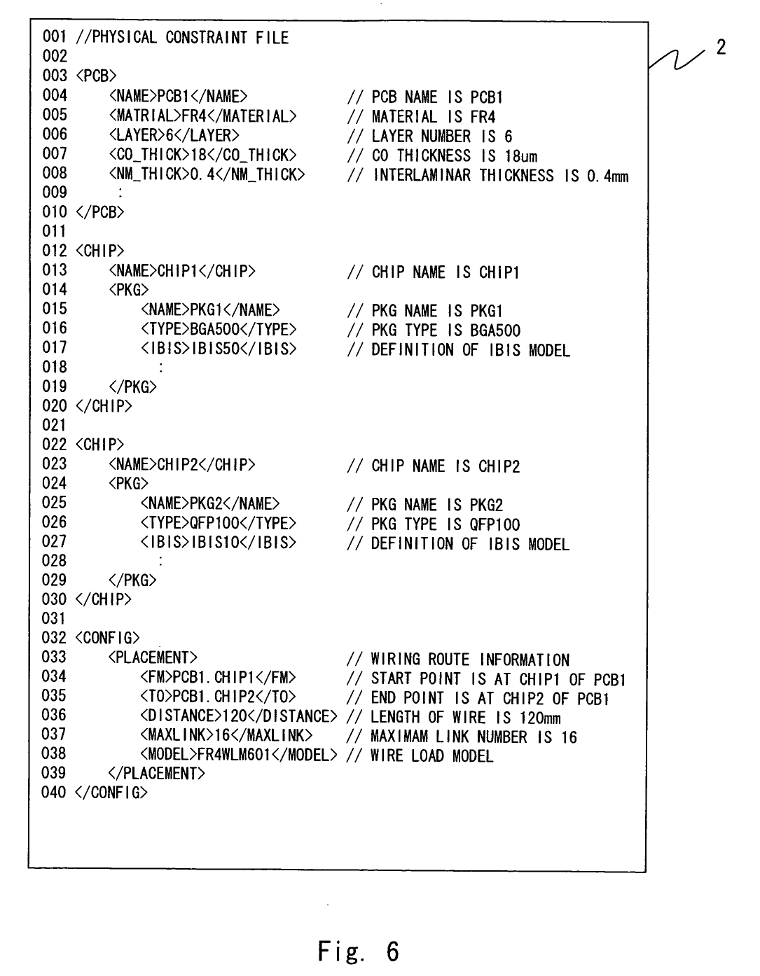

As shown in FIG. 4, it is firstly performed to read out a bus interface design library in step SP1. The contents of the bus interface design library are described later. Next, in step SP2, logical constraint conditions are inputted. Specifically, it is performed to read out a logical constraint file, such as the one shown in FIG. 5. Then, physical constraint conditions are inputted (step SP3). Specifically, it is performed to read out a physical constraint file, such as the one shown in FIG. 6. Then, a configuration parameter for a bus IP is calculated (step SP 4).

After carrying out the calculation of a parameter required for configuring the bus IP in the step SP4, configuration of a bus IP is performed (step SP 5). Finally, an RTL (Register Transfer Level) is outputted, and then the process of bus generation is completed (step SP6). Note that RTL represents a circuit of the configured bus IP with flip-flop and combinational logical circuits.

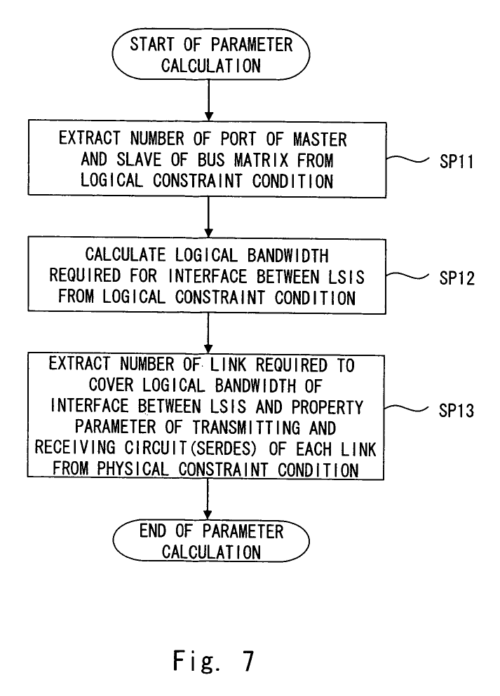

In the following description, details of the method of calculating a configuration parameter for a bus IP is described. FIG. 7 is a flow chart that shows a method of calculating a configuration parameter for a bus IP.

Firstly, a number of masters and a number of slaves in the bus matrix are read out from the logical constraint conditions. Subsequently, a number of master ports and a number of slave ports are determined, both of which are inside the bus IP and required for generation of a bus matrix unit (cross bar switch) that is for arbitrarily connecting a plurality of bus master modules with a plurality of bus slave modules (step SP11). Then, a logical bandwidth that is required for a high speed interface (link) connecting the system LSIs is calculated from route information (path information indicating which master accesses which slave) and information regarding the bus width and the bus clock frequency of each port of the logical constraint conditions (step SP12).

Subsequently, a number of links capable of realizing the logical bandwidth obtained in the step SP12 and a property parameter of a transmitting and receiving circuit (SERDES) that drives each link are calculated from the physical constraint conditions (step SP13). Examples of the property parameter of a transmitting and receiving circuit include the type of LVDS (Low Voltage Differential Signaling) buffer, the amount of deemphasis, in which the receiving side restores the frequency component emphasized by preemphasis of the transmitting circuit after demodulation, or preemphasis, in which the transmitting side emphasizes the high frequencies of modulation signal in advance, the amount of equalization in the receiving circuit, and the like.

The physical constraint conditions indicate information, such as the material of the print circuit board, the number of the print circuit board layers, the wiring film thickness and the thickness between the layers of the print circuit board, package information (the type of package, the model name of IBIS (Input/Output Buffer Information Specification)) of each system LSI, the distance of wirings between the system LSIs, the model of wiring load, and the maximum number of links allowed to be wired. IBIS is an ANSI (American National Standards Institute) standard model to describe input and output properties of ICs and indicates input and output properties of IC chips.

Means for calculating the property parameter is realized by searching a database, which is configured to output a parameter for the bus IP, with use of the above-mentioned physical constraint conditions as a key in a look-up table manner. After the above-described steps SP11 to SP13, the step of extracting the parameter for configuring the bus IP is completed.

Next, the bus interface design library 3 is explained. A configurable bus IP is stored in a bus interface (bus IP) design library 3. A configurable bus IP means a bus IP that can be customized in the architecture at the level of command sets in conformity with an application. In other words, a configurable bus IP has following parameters as its own, a bus clock frequency, a number of master ports, a number of slave ports, a data bus width of each port, start addresses and end addresses of the address regions (for the case of slaves), and a number of external high speed interfaces (number of links), property parameters of transmitting and receiving circuits (such as SERDES) of each link, and the like, and can reconfigure the internal circuit configuration in accordance with the specified parameter(s).

In the following description, referring to FIGS. 5 and 6, the specific contents of the logical constraint file and the physical constraint file are described. It should be noted that the logical constraint file and the physical constraint file have configurations that can keep hierarchical information structure in a similar format, such as HTML/XML.

FIG. 5 is a diagram that shows one specific example of the logical constraint file. A logical constraint file 1 in the present example is configured with, as major sections, two CHIP sections (from the line 003 to the line 023, and from the line 025 to the line 041) and one CONFIG section (from the line 043 to the line 052). The CHIP sections define the block configurations of the CHIPs 110 and 120 of FIG. 3.

Main items in the CHIP section of the CHIP 110 are described:

the line 004: this line directs that this is a section related to the CHIP 110;

the line 007: this line directs that the bus clock is 150 MHz;

the lines 009-011: this line directs that the bus master module M11 has a width of 32 bit and is an AHB (Advanced High-Performance Bus) (Registered Trademark) master port;

the lines 014-016: this line directs that the bus slave module S11 has a width of 32 bit and is an AHB slave port; and

the lines 018-019: this line directs that the address region of the bus slave module S11 is 0x10000000-0x1001ffff.

Next, main items in the CONFIG section are described:

the lines 044-047: this line directs that the bus master module M11 of the CHIP 110 accesses the bus slave module S11 of the CHIP 110; and

the lines 049-050: this line directs that the bus master module M11 of the CHIP 110 accesses the bus slave module S21 of the CHIP 120.

FIG. 6 is a specific example of the physical constraint file. A physical constraint file 2 in FIG. 6 is configured from following major sections, one PCB section (from the line 003 to the line 010), two CHIP sections (from the line 012 to the line 020, and from the line 022 to the line 030), and one CONFIG section. In the PCB section, the physical constraint conditions of the print circuit board PCB 101 in FIG. 3 are defined, and in the CHIP sections, the physical constraint conditions of the CHIPs 110 and 120 in FIG. 3 are defined. In the CONFIG section, the physical constraint conditions, such as layout wiring information, are specified. Main items in the PCB section are described below:

the line 005: this line directs that the material of the PCB 101 is FR-4 (flame resistant glass substrate epoxy resin laminated board);

the line 006: this line directs that the number of print circuit board layers of the PCB 101 is six;

the line 007: this line directs that the thickness of print circuit board copper foil film of the PCB 101 is 18 μm; and

the line 008: this line directs that the thickness between print circuit board layers of the PCB 101 is 0.4 mm.

Main items in the CHIP sections are described:

the line 017: this line directs that the package type number of the CHIP 110 is BGA 500 (ball grid array, 500 pins); and

the line 018: this line directs that the IBIS model for packaging the CHIP 110 is IBIS 50 (Input/Output Buffer Information Specification).

Main items in the CONFIG section are described:

the line 036: this line directs that the distance on the PCB 101 between the CHIPs 110 and 120 is 120 mm;

the line 037: this line directs that the maximum number of links allowed to be wired between the CHIPs 110 and 120 is 16; and

the line 038: this line directs that the wiring model between the CHIPs 110 and 120 is FR4WLM601 (FR4: the print circuit board material; WLM: Wire Load Model).

It should be noted that the IBIS 50 indicates an electrical model of PKG, and in the present example, a uniquely defined model name is indicated as an example. FR4WLM601 is an electrical model of wiring of the print circuit board, and in the present example, a uniquely defined model name is indicated as an example.

In the present exemplary embodiment, it is achieved to generate bus interfaces that satisfies the physical constraint conditions in a high speed interface between a plurality of LSIs and is capable of being stably driven, and thus it is achieved to avoid the redesign or readjustment of a package substrate, a print circuit board, cables, and the like, after LSI design process is completed.

In addition, a plurality of bus interfaces (circuits) are conventionally prepared in advance as libraries to be selected in conformity with the requests (specifications) by a client and embedded in LSIs, such as ASICs (Application Specific Integrated Circuit). For this reason, problems arise such that an interface between the system LSIs does not stably operate because of the changes in electrical properties due to physical factors and a target transfer bandwidth cannot be achieved. In contrast, in the present exemplary embodiment, since the ASIC usage conditions of a client is determined in advance as the physical constraints, and a bus interface (circuit) optimum for each ASIC is produced, the above-mentioned problems can be avoided as a result.

### Second Exemplary Embodiment

Another exemplary embodiment will be described in which, instead of the SERDESes in the first exemplary embodiment, a high speed parallel interface (such as a DDR (Double Data Rate) interface) can be used as the high speed interfaces and at the same time a configuration is provided which has a function capable of selecting high speed serial or high speed parallel. The bus interface design apparatus has means for determining an optimum type of high speed interface by searching a database prepared in advance using the following value as a key, a number of usable external terminals (number of slots) which is restricted by the package type of the system LSIs, a bandwidth required for communication between the LSIs, and an upper limit value of the transmission speed determined by a material of the print circuit board and wiring information as keys.

The present exemplary embodiment is also related to design of system LSIs similar to the first exemplary embodiment and related to an apparatus for designing a bus IP core that includes a bus interface interposed between chips. In the present exemplary embodiment as well, by determining the bus width of an interface between the chips, the type of interface, and the like based on the physical constraint conditions of the chips, a bus IP core can be automatically generated which is equipped with the determined bus width and interface circuit.

It should be noted that the present invention is not limited only to the exemplary embodiments described above, and it should be understood that various modifications can be made without departing from the spirit of the present invention. For example, although the present invention is described in the form of hardware configurations in the exemplary embodiments described above, it is not limited to those and is also possible to realize any process by making a CPU (Central Processing Unit) to execute a computer program. In this case, it is also possible to provide the computer program by recording in a recording medium, and in addition, it is also possible to provide by transmission via other transmission media, such as the Internet.

In the exemplary embodiments described above, the following programs are disclosed. One is a program for making a computer to execute a process for designing a bus interface that includes an I/F interposed between chips, including: determining a bus width of the bus interface between the chips and a type of the bus interface, based on a physical constraint condition of the chips; and automatically generating a bus IP core that includes a circuit configured in accordance with the determined bus width and bus interface.

Another is a program for making a computer to execute a predetermined operation, including: reading a bus interface design library; reading a logical constraint condition and a physical constraint condition upon designing the bus interface; calculating a parameter required for the configuration of the bus interface; and executing the configuration of the bus interface.

The bus interface is an interface of a bus that connects a plurality of semiconductor integrated circuits, the bus interface including: a transmitting and receiving circuit which drive the bus; and a serial interface and/or a parallel interface, wherein the parameter is property parameter of the transmitting and receiving circuit, and the serial interface and/or the parallel interface.

IN the exemplary embodiments described above, the following design system is disclosed. A system for designing a bus interface that includes an I/F interposed between chips, the system including: a determinator that determines a bus width of the bus interface between the chips and a type of the bus interface based on a physical constraint condition of the chips; and an executor that automatically generates a bus IP core that includes a circuit configured in accordance with the determined bus width and bus interface.

The first and second exemplary embodiments can be combined as desirable by one of ordinary skill in the art.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A design method of a bus interface that includes an I/F interposed between chips, comprising:
determining a bus width of the bus interface between chips and a type of the bus interface, based on a physical constraint condition between the chips; and
automatically generating a bus IP core that comprises a circuit configured in accordance with the determined bus width and the bus interface.

2. The design method of the bus interface according to claim 1, further comprising:
reading a bus interface design library in which a plurality of bus interface data of a chip-connecting bus are registered;
determining at least bus width and bus interface data based on the physical constraint conditions between chips;
automatically generating a bus IP core that comprises a circuit configured in accordance with the determined bus width and the bus interface data.

3. The bus interface design method according to claim 1, wherein
the bus interface includes one or more bus master modules, one or more bus slave modules, and a bus matrix unit for arbitrarily connecting at least one of the bus master modules and at least one of the bus slave modules.

4. The bus interface design method according to claim 1, wherein
the physical constraint condition includes at least one selected from a material of a print circuit board, a number of print circuit board layers, a wiring film thickness and a thickness between layers of the print circuit board, package information of an individual system LSI, a wiring distance between system LSIs, a wiring load model, and a maximum number of links allowed to be wired.

5. The bus interface design method according to claim 2, wherein
the logical constraint condition includes at least one selected from route information, which is path information indicating which master accesses which slave, a bus width and a bus clock frequency of an individual port.

6. A bus interface design method comprising:
reading a logical constraint condition between chips and a physical constraint condition between the chips;
calculating a parameter required for a configuration of a bus interface; and
automatically generating the bus interface by performing the configuration of the bus interface.

7. The bus interface design method according to claim 6, wherein
the bus interface includes a transmitting and receiving circuit that drives a bus that connects the chips, and
the parameter is a property parameter of the transmitting and receiving circuit.

8. The bus interface design method according to claim 6, wherein
the bus interface includes a serial interface and/or a parallel interface that drives a bus that connects the chips, and
the parameter is a property parameter of the serial interface and/or the parallel interface.

9. The bus interface design method according to claim 6, wherein
the parameter is calculated by searching a database, which is configured to output the parameter, with use of the physical constraint condition as a key in a look-up table manner.

10. The bus interface design method according to claim 6, wherein
the property parameter is calculated by:
determining a number of master ports and a number of slave ports which are required for generating a bus matrix unit for arbitrarily connecting a plurality of bus master modules with a plurality of bus slave modules;
calculating a logical bandwidth required for an interface, which connects the chips, from the logical constraint condition; and
calculating a number of interfaces capable of realizing the logical bandwidth and the parameter of the transmitting and receiving circuit that drives each interface, from the physical constraint condition.

11. The bus interface design method according to claim 7, wherein
the property parameter includes at least one selected from a type of LVDS (Low Voltage Differential Signaling) buffer, an amount of deemphasis, an amount of preemphasis, and an amount of equalization in a receiving circuit.

12. The bus interface design method according to claim 7, wherein
the parameter of the configurable bus interface is stored in a bus interface design library,
the parameter includes at least one selected from a bus clock frequency, a number of master ports, a number of slave ports, a data bus width of each port, a start address and an end address of an address region for the case of slaves, a number of external interfaces, and a property parameter of a transmitting and receiving circuit of each external interface, and
an internal circuit configuration is reconfigured in accordance with the specified parameter.

13. A bus interface design apparatus comprising:
a data readout unit that read out a bus interface design library and a physical constraint condition of chips, the bus interface design library being configured by registering a plurality of design purpose bus interfaces, each of the plurality of design purpose bus interfaces being for a bus that connects chips;
a determinator that determines a bus width and the design purpose bus interface based on the physical constraint condition; and
an executor that automatically generates a bus IP core that comprises a circuit configured in accordance with the determined bus width and the design purpose bus interface.

14. The bus interface design apparatus according to claim 13, further comprising:
a parameter calculator that calculates a parameter required for a configuration of the bus interface, wherein
the executor executes the configuration of the bus interface based on the parameter calculated by the parameter calculator.

15. The bus interface design apparatus according to claim 14, further comprising:
a transmitting and receiving circuit that drives the bus connecting semiconductor integrated circuits, wherein
the parameter is a property parameter of the transmitting and receiving circuit.

16. The bus interface design apparatus according to claim 14, wherein
the bus interface includes a serial interface and/or a parallel interface which drive the bus that connects semiconductor integrated circuits, and
the parameter is a property parameter of the serial interface and/or the parallel interface.

17. The bus interface design apparatus according to claim 13, wherein
the bus interface includes one or more bus master modules, one or more bus slave modules, and a bus matrix unit for arbitrarily connecting at least one of the bus master modules and at least one of the bus slave modules.

18. The bus interface design apparatus according to claim 17, wherein
the parameter calculator calculates the parameter by searching a database, which is configured to output the parameter, with use of the physical constraint condition as a key in a look-up table manner.

19. The bus interface design apparatus according to claim 15, wherein
the parameter calculator comprises:
a port number determinator that determines a number of master ports and a number of slave ports which are required for generating a bus matrix unit that is for arbitrarily connecting a plurality of bus master modules with a plurality of bus slave modules;
a bandwidth calculator that calculates a logical bandwidth from the logical constraint condition, the logical bandwidth being required for an interface that connects the semiconductor integrated circuits; and
a parameter output unit that calculates a number of interfaces capable of realizing the logical bandwidth and the parameter of the transmitting and receiving circuit that drives each interface, from the physical constraint condition.
